(19) United States
(12) Patent Application Publication
(10) Pub. No.: US 2026/0119401 A1
(43) Pub. Date: Apr. 30, 2026

(54) DCT MECHANISM FOR THE MULTI-CHIP SYSTEMS

(71) Applicant: Arm Limited, Cambridge (GB)

(72) Inventors: Sai Kumar Marri, Austin, TX (US); Ashok Kumar Tummala, Cedar Park, TX (US); Mark David Werkheiser, Austin, TX (US); Jamshed Jalal, Austin, TX (US); Tarun Kumar Nandi Suresh Babu, Leander, TX (US)

(73) Assignee: Arm Limited, Cambridge (GB)

(21) Appl. No.: 19/077,329

(22) Filed: Mar. 12, 2025

Related U.S. Application Data
(60) Provisional application No. 63/714,550, filed on Oct. 31, 2024.

(51) Int. Cl. G06F 12/0815

(52) U.S. Cl. CPC G06F 12/0815; G06F 2212/1024

(57) ABSTRACT

Direct Cache Transfer is enabled in a multi-chip data processing apparatus which one or more links do not support forwarding snoop requests. A gateway of a link in the multi-chip data processing apparatus is configured to intercept data messages. A data message is generated when a request node of a network sends a data request to a home node, and the home node sends a corresponding snoop request to a snoop target. When the gateway determines that a data message is associated with a response to a forwarding snoop request from a home node, the message is rerouted to the request node, bypassing the home node.

### CROSS-REFERENCE TO RELATED APPLICATIONS

This patent application claims the benefit of U.S. Provisional Application No. 63/714,550, filed Oct. 31, 2024, entitled “DIRECT CACHE TRANSFER (DCT) MECHANISM FOR THE MULTI-CHIP SYSTEMS,” which is hereby incorporated by reference in its entirety.

### BACKGROUND

The complexity of data processing networks, such as mesh networks, is increasing in terms of the number of network nodes and the number of networks links. This increase is driven, at least in part, to support large computational and memory requirements. A network may use a system level cache (SLC) to reduce data access latency. In some current systems, the system level cache is distributed across a large set of home nodes in the network to share the cache capacity over all request nodes across multiple chips. The resulting networks, with large mesh dimensions, can exhibit large latencies for the read requests and associated snoop requests.

A hierarchy of cache nodes may be used, with the home nodes providing the last level in the hierarchy. The hierarchy may include local cache nodes, physically close to nodes that process data.

To reduce access latency incurred when accessing a subordinate node and associated memory, a home node may retrieve requested data by sending snoop requests to nodes that have copies of requested data in their local caches. This avoids the latency incurred when accessing a memory.

To reduce latency further, a “direct cache transfer” may be requested by sending a “forwarding snoop” message from the home node to the snoop target. In this case, the requested data is forwarded directly from the cache of the snoop target to the requesting node, bypassing the home node.

However, the home node and the snoop target may be located on different chips, connected by a link. In this case, a direct cache transfer cannot be performed when the link does not support forwarding snoop requests or when the network on the snoop target chip does not support forwarding snoop requests.

### BRIEF DESCRIPTION OF THE DRAWINGS

The accompanying drawings provide visual representations which will be used to describe various representative embodiments more fully and can be used by those skilled in the art to understand better the representative embodiments disclosed and their inherent advantages. In these drawings, like reference numerals identify corresponding or analogous elements.

FIG. 1 is a simplified diagram of a multi-chip data processing network.

FIG. 2 is a block diagram of a gateway of a data processing network, in accordance with various representative embodiments.

FIG. 3a is a simplified block diagram of a multi-chip data processing apparatus.

FIG. 3b is a table of message attributes associated with FIG. 3a.

FIG. 4a is a block diagram of a data processing apparatus 400, in accordance with various representative embodiments.

FIG. 4b is a table of message attributes associates with FIG. 4a.

FIG. 5a is a block diagram of a data processing apparatus, in accordance with various representative embodiments.

FIG. 5b is a table of message attributes associated with FIG. 5a.

FIG. 6a is a block diagram of a data processing apparatus, in accordance with various representative embodiments.

FIG. 6b is a table of message attributes associated with FIG. 6a.

FIG. 7a is a block diagram of a data processing apparatus, in accordance with various representative embodiments.

FIG. 7b is a table of message attributes associated with FIG. 7a.

FIG. 8a is a block diagram of a data processing apparatus, in accordance with various representative embodiments.

FIG. 8b is a table of message attributes associated with FIG. 8a.

FIGS. 9-11 are a block diagrams of chips, in accordance with various representative embodiments.

FIGS. 12-14 show example embodiments in multi-chip data processing networks, in accordance with various representative embodiments.

FIG. 15 is a flow chart of a method of data transfer in a data processing apparatus, in accordance with various representative embodiments.

### DETAILED DESCRIPTION

The various apparatus and devices described herein provide mechanisms for Direct Cache Transfer in a data processing network.

Direct Cache Transfer (DCT) is a mechanism by which data is directly shared between the requestors without passing through the home node. The transfer is initiated by the home node by sending a forwarding snoop request (FWD snoop) containing the node identifier of the forward requestor. In current networks, this mechanism can only be used within a single chip. For multi-chip configuration, standard chip-to-chip link protocols, such as the Arm® AMBA® 5 CHI Chip-to-Chip (CHI-C2C) architecture specification of Arm Ltd., the CCIX® coherent interconnect of the CCIX® Consortium, and the Compute eXpress Link (CXL®) specification of Compute Express Link Consortium, Inc. do not support a DCT mechanism. This can result in large latencies when the home node and the snoop target are located on different chips.

While this present disclosure is susceptible of embodiment in many different forms, there is shown in the drawings and will herein be described in detail specific embodiments, with the understanding that the embodiments shown and described herein should be considered as providing examples of the principles of the present disclosure and are not intended to limit the present disclosure to the specific embodiments shown and described. In the description below, like reference numerals are used to describe the same, similar, or corresponding parts in the several views of the drawings. For simplicity and clarity of illustration, reference numerals may be repeated among the figures to indicate corresponding or analogous elements. In particular, the disclosure describes embodiments in one or more gateways of a chip-to-chip link. More generally, the disclosure may be embodied in any network-to-network link, whether the link is between networks on different chips or between networks on the same chip.

Various embodiments of the disclosure enable Direct Cache Transfer (DCT) of data across multiple chips. This improves the total latency of the original read request and the associated snoop transaction. For example, mesh latency in a coherent mesh network, and the cross-chip link latency of both the snoop response and the data response, can be eliminated by forwarding the data from the snoop target to the requestor across chips.

The link may couple between networks on the same chip, or chiplet, or may be a chip-to-chip link in a multi-chip data processing network. Herein, a “chip” is taken to include semi-conductor dies coupled via a printed circuit board (PCB) or semi-conductor dies, sometimes referred to as “chiplets,” packaged in a multi-chip module. Unless otherwise specified, the term “chip” is used to describe both chips and chiplets.

The disclosure is described with reference to a chip-to-chip link between chips (or chiplets) of a multi-chip data processing network. However, it is to be understood that the disclosure may be embodied in other network links. In particular, the link may be between networks on the same chip or between networks on different chips. Thus, the mechanisms used in a chip-to-chip link may be applied in a general network-to-network link. Gateways to the network-to-network link, including gateway transmitters and receivers, are provided in each network. The mechanism may be used, for example, where a link between networks on the same chip does not support forwarding snoop requests (FWD snoops), or when one of the networks does not support FWD snoops. A “link” may directly couple two chips or may span one or more chips. Thus, a “link” may include one or more direct chip-to-chip links.

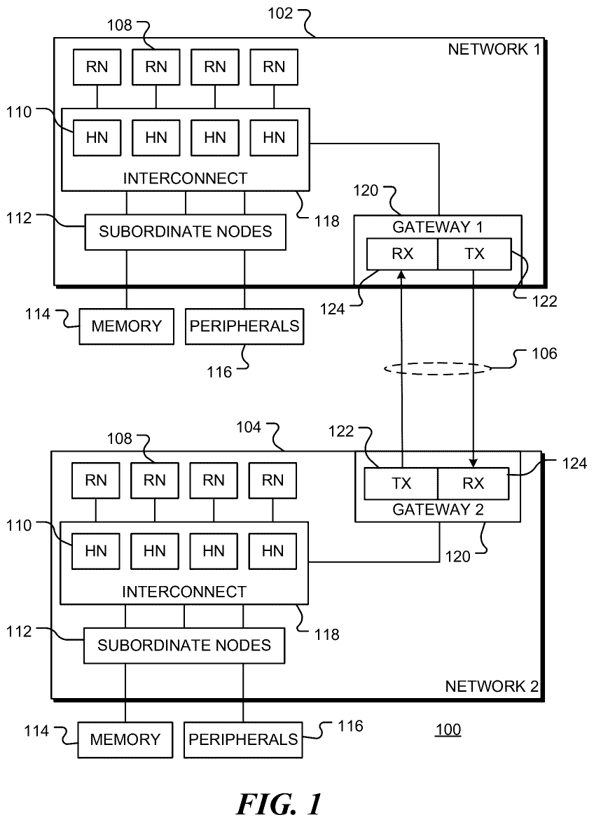

FIG. 1 is a simplified diagram of a multi-chip data processing network 100. The network includes a first integrated circuit chip 102 (“CHIP 1”) and second integrated circuit chip 104 (“CHIP 2”), coupled by chip-to-chip (C2C) link 106 that enables communication of information between the two chips. Each chip includes request nodes (RNs), e.g., 108, home nodes (HNs), e.g., 110, and subordinate nodes 112 (SNs). While a small number of nodes is shown in FIG. 1, a network may contain any number of nodes.

The request nodes (RNs) access and process data. A request node (RN) can be Fully Coherent, input/output (I/O) Coherent, or I/O Coherent with Distributed Virtual Memory (DVM) support. A Fully Coherent Request Node (RN-F) contains coherent caches and will accept and respond to snoop requests for accessing or changing the coherency state of cached data. An I/O-Coherent Request Node (RN-I) does not have a coherent cache and cannot accept snoop requests. An I/O-Coherent Request Node with DVM support (RN-I/D) has the same functionality as an RNI and can also accept DVM messages. A request node may be, for example, a central processing unit (CPU) core, a neural engine or other accelerator, or a Component Aggregation Layer that houses two or more CPU cores to be connected to one network port.

A network may include a system level cache (SLC) to reduce the number of accesses to memory and reduce the latency of data accesses. The system level cache may be distributed across a large set of home nodes in a network to share the cache capacity over all network nodes across multiple chips. A home node (HN) provides a point of coherency for a subset of system address and provides a cache for storing data associated with the addresses. Coherency may be provided by a snoop filter (SF) that tracks data copied to caches in the network caches.

Subordinate nodes 112 provide access to data sources and sinks, such as memory 114 and peripheral devices 116. A memory or peripheral device may be located off-chip, as shown, or on-chip.

Interconnect 118 provides signal connections between the nodes and may have various topologies. For example, interconnect 118 may be configured to form a mesh network, a ring network, a crossbar network, or other network. The interconnect may provide a number of cross-points (XPs). Each cross-point provides one or more ports for coupling to request nodes and home nodes.

Gateways 120 are chip-to-chip nodes (C2C nodes or CCNs) that couple between the network on one chip and a network on another chip. This enables formation of a network spanning multiple chips.

A gateway 120 includes a transmitter 122 and a receiver 124 that interface to link 106. C2C link 106 is responsible for handling message transport at a FLow control unIT (Flit) granularity. C2C link 106 may also be responsible for data integrity and transport error detection and recovery. This may be done, for example, by adding a generated Cyclic Redundancy Check (CRC) checksum to a flit being transmitted and checking the CRC checksum on the received flit. When an error occurs, the C2C link can use a flit retry mechanism to recover from the error. The C2C link includes a physical layer that is responsible for providing reliable electrical connectivity between the two chips. The physical layer may also include logic to overcome latency skew among different signals, together with link retraining logic to maintain signal integrity.

Embodiments of the disclosure provide a method of data transfer in a data processing apparatus, in which, responsive to receiving, at a home node of a first network, a read request from a request node of the data processing apparatus, the home node generates a first snoop request targeting a snoop target of a second network, where the first snoop request is a forwarding snoop request and the second network is operatively coupled to the first network by a link. Responsive to receiving the first snoop request at a first gateway of the link, located on the first network, a second snoop request is transported to a second gateway of the link, located on the second network, in accordance with a link protocol. The second snoop request is a non-forwarding snoop request. Responsive to receiving the second snoop request at the second gateway, the second gateway generates a third snoop request as a forwarding snoop request or a non-forwarding snoop request and the third snoop request, or a snoop request derived therefrom, is transported to the snoop target. In response to receiving the third snoop request, or the snoop request derived therefrom, the snoop target sends data associated with the read request in a data message. In an embodiment where the third snoop request is a non-forwarding snoop request, the data message targets the home node but is intercepted at a link and routed to the request node. In an embodiment where the third snoop request is a forwarding snoop request, the read request is received at the second gateway, and the second gateway synthesizes the third snoop request as a forwarding snoop request based, at least in part, on routing information for in the read request. The snoop target sends a data message to the request node responsive to receiving the third snoop request.

In one embodiment, when the third snoop request is a forwarding snoop request to a third gateway between the home node and the snoop target, the third gateway intercepts the data response and re-routes it to the request node.

In one embodiment, the data message is intercepted at the first gateway of the link and re-routed to the request node, based request node routing information in the first snoop request.

In one embodiment, the read request is routed through the second gateway and the method includes setting a hint bit in the second snoop request indicating that the first snoop request was a forwarding snoop request. In this embodiment, intercepting the data message at the link and re-routing the data message to the request node is performed at the second gateway of the link based, at least in part, on request node routing information in the read request.

In one embodiment, the read request is routed through the second gateway and the method includes setting a hint bit in the second snoop request indicating that the first snoop request was a forwarding snoop request. When the third snoop request is a forwarding snoop request, the forwarding snoop request is synthesized at the second gateway based, at least in part, on request node routing information in the read request.

In one embodiment, the method includes copying, at the first gateway, request node routing information from the first snoop request to one or more designated fields of the second snoop request and storing the request node routing information at the second gateway.

In one embodiment, the third snoop request is a non-forwarding snoop request and intercepting the data message at the link and re-routing the data message to the request node includes intercepting the data message at the second gateway and re-routing the data message from the second gateway to the request node based on the request node routing information in the one or more designated fields of the second snoop request.

In one embodiment, the first network is on a different chip or chiplet from the second network, and the link is a chip-to-chip link that does not support forwarding snoops.

Various embodiments of the disclosure is data processing apparatus that includes a link having a first gateway and a second gateway, a first network including a home node and the first gateway, a second network including a snoop target and the second gateway, the second network operatively coupled to the first network via the link, and a request node. The request node is configured to send a read request to the home node. The home node is configured to send, responsive to receiving the read request, a first snoop request targeting the snoop target to the first gateway. The first gateway is configured to send, responsive to receiving the first snoop request, a second snoop request to the second gateway via the link, in accordance with a link protocol. The second gateway is configured to send, responsive to receiving the second snoop request, a third snoop request to the snoop target. The snoop target is configured such that, when the third snoop request is a forwarding snoop request, the snoop target sends data associated with the read request in a data message targeting the request node and sends a snoop response message to the home node. The snoop target is configured such that, when the third snoop request is not a forwarding snoop request, the snoop target sends data associated with the read request in a data message targeting the home node. The link is configured such that, when the third snoop request is not a forwarding snoop request, the data message is intercepted at the link and re-routed to the request node.

In one embodiment, at least one of the first and second gateways includes a transmitter configured to pass messages to the link, a receiver configured to receive messages from the link, and forward snoop logic circuitry coupled to the transmitter and to the receiver. The forward snoop logic circuitry is configured to store request node routing information received in the first snoop request, intercept a data message from the snoop target, determine when the data message is associated with the first snoop request, and when the data message is associated with the first snoop request, send the data message from the first gateway to the request node, based on the request node routing information.

Various embodiments of the disclosure relate to a data processing apparatus that includes a gateway to a chip-to-chip link of a data processing apparatus. The gateway includes a transmitter configured to pass messages to a chip-to-chip link, where the link is configured to couple between first and second chips of a data processing apparatus, a receiver configured to receive messages from the chip-to-chip link, and forward snoop logic circuitry coupled to the transmitter and to the receiver. The forward snoop logic circuitry is configured to store request node routing information for a request node of the data processing apparatus. The request node routing information may be obtained from a read request of from the request node or from a first snoop request, where the first snoop request is a forwarding snoop request generated by a home node of the first chip in response to the read request, and where the first snoop request targets a snoop target on the second chip. The gateway is configured to intercept a data message from the snoop target, determine when the data message is a snoop response associated with read request. When the data message is a snoop response associated with read request, the data message is sent from the gateway to the request node, based on request node routing information.

In one embodiment, the gateway is further is configured to receive, at the transmitter, the first snoop request from the home node, and send a second snoop request, via the transmitter and the link to the second chip, where the second snoop request is a non-forwarding message.

In one embodiment, the gateway is also configured to receive, at the receiver from the link, a second snoop request, where the second snoop request is a non-forwarding message generated from the first snoop request, and retrieve the one or more attributes of the read request from one or more designated data fields in the second snoop request.

In one embodiment, the forward snoop logic circuitry is configured to loop the data message from the receiver to the transmitter or to loop the data message from the transmitter to the receiver.

Computer-readable code for fabrication of the gateway in a chip may be stored on non-transitory computer-readable medium.

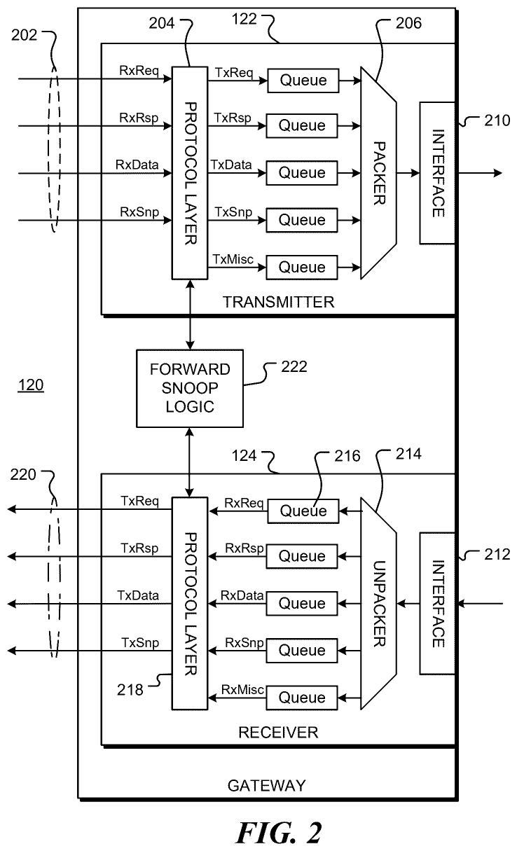

FIG. 2 is a block diagram of a gateway 120, in accordance with various representative embodiments. Gateway 120 includes transmitter 122 and receiver 124. Transmitter 122 is an interface component that receives messages from an on-chip interconnect and forwards them to chip pins for coupling to a C2C Link. In the example shown in FIG. 2, the messages are received on four separate channels 202 and include request messages on channel “RxReq,” response messages on channel “RxRsp,” data messages on channel “RxData,” and snoop requests on channel “RxSnp.” The received messages are reformatted for transmission on the C2C link in protocol layer circuit 204. For example, protocol layer circuit 204 may handle protocol conversion between on-chip message format (such as Arm® AMBA® 5 CHI specification of Arm Limited) and a C2C link format (such as Arm® AMBA® CHI C2C of Arm Limited). The reformatted messages are passed on channels “TxReq,” “TxRsp,” “TxData” and “TxSnp,” respectively, together with additional information on channel “TxMisc,” to message queues or buffers and then passed to packer circuit 206, where they are packed into fixed-sized containers, such as container 208, for transmission on the C2C link via interface 210. The protocol layer translates transactions and cache states between the on-chip interconnect protocol and the off-chip link protocol.

Receiver 124 is an interface component that receives message from a C2C link at interface 212. The message is unpacked by unpacker circuit 214 to recover received messages on channels “RxReq,” “RxRsp,” “RxData” and “RxSnp”, respectively, together with additional information on channel “RxMisc”. The messages may be queued in queue buffers 216 before being reformatted in protocol layer circuit 218 from the C2C link protocol to the on-chip message protocol. The reformatted messages are then transmitted to the on-chip interconnect of the chip on channels “TxReq,” “TxRsp,” “TxData” and “TxSnp” (220).

In multi-chip systems, a home node snoop filter tracks the requestors belonged to local chip and remote chips. Without a multi-chip DCT mechanism, the home node or the gateway downgrades the forwarding snoop requests (FWD snoops) to regular snoop requests that belonged to remote requestors.

DCT is not supported in cross-chip link protocols such as CHI-C2C/CXL/CCIX because each chip has their own identification scheme for nodes. Home nodes cannot derive the FWD node-identifiers for the remote requestors. Similarly, the snoop target cannot send direct cache transfer to the remote requestor.

In accordance with embodiments of the present disclosure, gateway 120 includes forward snoop logic circuitry 222 that enables DCT in multi-chip data processing networks. Forward snoop logic circuitry 222 is coupled to transmitter 122 and receiver 124 and is configured to intercept data messages that target the cache node. When a data message is associated with FWD snoops, the intercepted data message is re-routed to the request node that requested the data.

In one embodiment, a gateway 120 on a first chip receives FWD snoops on channel “RxSnp” of input 202 from a home node on the first chip. The FWD snoop is converted to a non-forwarding snoop request in protocol layer 204 and via interface 210 and the C2C link to a snoop target on a second chip.

The data sent from the snoop target is received at receiver 124. Forward snoop logic circuitry 122 associates the data with a corresponding FWD snoop and re-routes the data to the request node based on information (such as the node identifier of the request node) in the corresponding FWD snoop. When the request node is on the first chip, the data is sent on the “TxData” channel of channels 220. When the request node is on the second chip, the data is sent to transmitter 122. That is, the data is looped back to the second chip. In both cases, the data bypasses the home node, thereby reducing latency in the transaction.

In one embodiment, a gateway 120 on a first chip receives FWD snoops on channel “RxSnp” of input 202 from a home node on the first chip. The FWD snoop is converted to a non-forwarding snoop request in protocol layer 204 and via interface 210 and the C2C link to a snoop target on a second chip. Information from the FWD snoop, such as the node identifier of the request node and/or a transaction identifier of the read request, is written to one or more designated fields of the non-forwarding snoop request. The designated fields may include a “user data” field, for example.

In one embodiment, a gateway 120 on a second chip receives a non-forwarding snoop request at interface 212 of receiver 124 from the C2C link. The snoop request is associated with a read request from a request node on the second chip. The non-forwarding snoop request includes forwarding information, such as the node identifier of the request node, in one or more designated fields of the non-forwarding snoop request. The non-FWD snoop is sent to the snoop target and the resulting data message from the snoop target (targeting the home node on the first chip) is received at transmitter 122. Forward snoop logic circuitry 122 intercepts the data message and reroutes the message to receiver 124 to be sent to the request node. This avoids sending the data across the C2C link to the home node.

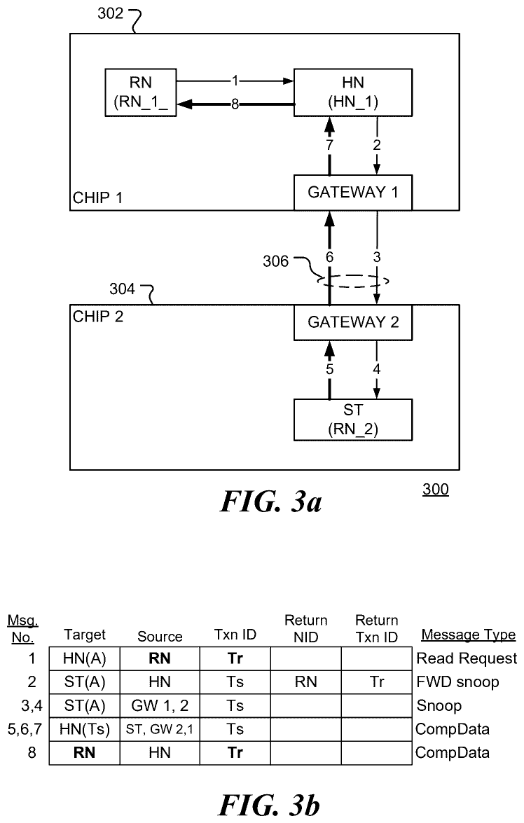

FIG. 3a is a simplified block diagram of a multi-chip data processing apparatus 300 including first chip 302 and second chip 304. First chip 302 contains request node RN (with node identifier RN_1), home node HN (with node identifier HN_1) and first gateway, GATEWAY 1, to link 306. Second chip 304 contains snoop target ST (with node identifier RN_2), and second gateway, GATEWAY 2, to C2C link 306. In practice, the identifiers may be designated numerical values. The arrows denote messages or signals between the nodes and gateways in accordance with prior systems.

FIG. 3b identifies the message types and shows some of the information contained in the messages shown in FIG. 3a. Thus, message 1 is a read request from the request node to the home node for address “A”. The transaction identifier for the read request is denoted as “Tr.” The node identifier of the home node is denoted as HN(A) to indicate the dependence on address A. A home node for an address may be identified from a system address map, for example. Message 2 is a FWD snoop request from the home node targeting the snoop target. The link does not support DCT, so the FWD snoop is downgraded to a non-forwarding snoop request in the link (message 3) that, in turn, is sent the snoop target in message 4. The data retrieved from the snoop target is sent back to the home node, via the C2C link, in messages 5, 6 and 7 and finally forwarded to the request node in message 8. The snoop response is routed according to a snoop transaction identifier “Ts.” Thus, the data is routed via the home node and there has been no direct cache transfer.

In an embodiment of the disclosure, a gateway of a link connecting two chips enables indirect DCT mechanism by supporting the FWD snoops. The data is sent to the requestor and, optionally, a forward response is generated and sent to the home node.

A first embodiment of the disclosure relates to Direct Cache Transfer (DCT) when the requestor and home node are in a first chip, and the snoop target is in a second chip.

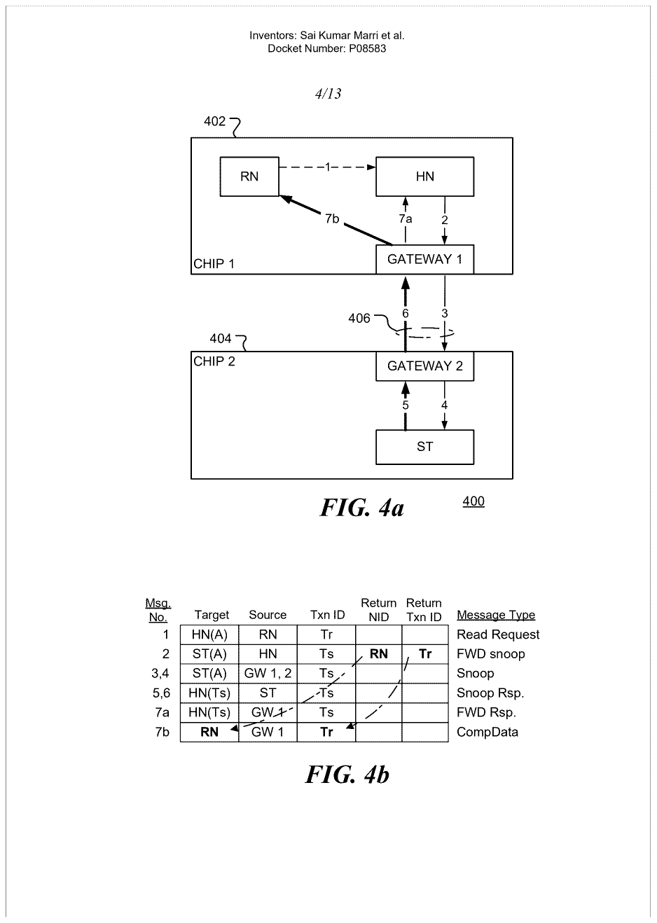

FIG. 4a is a block diagram of a data processing apparatus 400, in accordance with various representative embodiments. In the example shown, the original read requestor (RN) is in the same chip (402) as the home node (HN), while the snoop target (ST) is on a second chip 404. Messages 1-6 are the same as described above in reference to FIGS. 3a and 3b, but in this embodiment, the link gateway (GATEWAY 1) on chip 1 forwards the data to the requestor (RN) in message 7b, using attributes captured from FWD snoop (message 2). The attributes include the node identifier (for routing purposes) and, optionally, a transaction identifier (for linking this response to read request). Optionally, a FWD snoop response may be sent the home node (HN) in message 7a. Optionally, the requestor may send a completion acknowledgement message to the home node when it receives the data. This informs the home that the transaction is complete and the home update its snoop filter and free any resources allocated to the transaction.

This embodiment implements an indirect DCT mechanism, in which GATEWAY 1 sends a direct cache transfer (message 7b) to the requestor, bypassing the home node. This avoids the latency that would have occurred if the data had been sent first to home node and then to the requestor.

In a mesh network, latency reduction is directly proportional to the mesh size. In some embodiments, for example, this may be 10 to 20 cycles.

Both networks may be aware, through a global system address map for example, of node identifiers in the other network. More usually, nodes in a network are only aware of other nodes in the same network. The snoop filter of home node indicates a hit in network 2 for the read address in message 1 but does not identify which node in network 2 has the data. The home node sends message 2 to GATEWAY 1 for passing to network 2. GATEWAY 2, in turn, maps the read address in message 2 to the snoop target in network 2. In this embodiment, messages (including read requests, snoop request and data message) are routed first the gateway in network or chip where they are located, and then to the appropriate node in that network. A read request and a forward snoop request contain sufficient routing information to enable a response to be forwarded back to the request node. This information indicates, for example, that a response should be sent to an intermediate forwarding node, at which additional routing information is stored to enable the response to be forwarded. For example, a response may be routed to a gateway on the same chip as the request node, at which additional information (in a request tracker table, for example) is stored to enable the request node to be identified.

FIG. 4b identifies the message types and shows some of the information contained in the messages shown in FIG. 4a. Thus, message 1 is a read request from the request node to the home node for address “A”. The transaction identifier for the read request is denoted as “Tr.” The node identifier of the home node is denoted as HN(A) to indicate the dependence on address A. A home node for an address may be identified from a system address map, for example. Message 2 is a FWD snoop request from the home node targeting the snoop target. The link does not support DCT, so the FWD snoop is downgraded to a non-forwarding snoop request in the link (message 3) that, in turn, is sent the snoop target in message 4. The data retrieved from the snoop target is sent back towards the home node, in messages 5, 6 but is intercepted at gateway 1. The requestor node identifier (RN) and transaction identifier (Tr) from message 2, which were stored at the gateway, are copied to message 7b and the message forwarded to the request, bypassing the home node. FWD response 7a may be sent to the home node.

Various embodiments are described below for a data processing apparatus in which nodes in one network are unaware of node identifiers in another network However, it is to be understood that other routing schemes, as described above for example, may be used without departing from the present disclosure.

A second embodiment of the disclosure relates to Direct Cache Transfer (DCT) when the home node is in the first chip, while the requestor and snoop target are in the second chip.

### Option 1. Loopback at the First Chip Gateway.

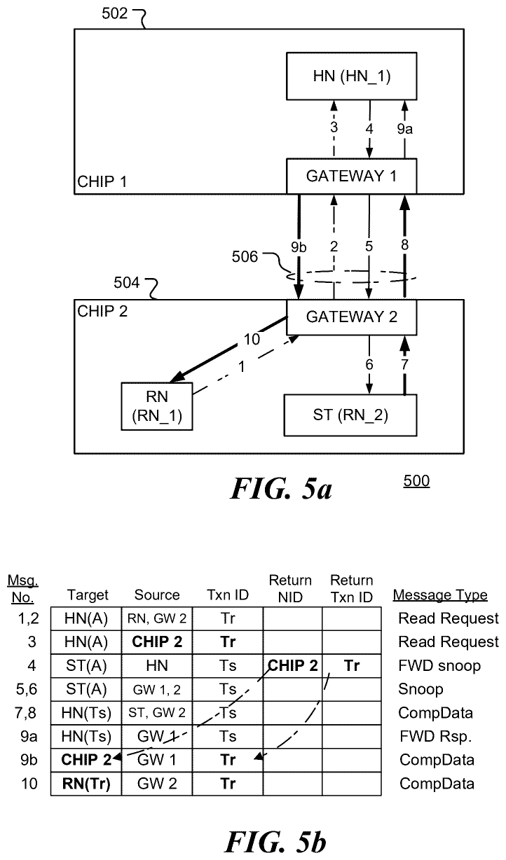

FIG. 5a is a block diagram of a data processing apparatus 500, in accordance with various representative embodiments. In the example shown, the home node (HN) is in first chip 502, while the original read requestor (RN) and the snoop target (ST) are in second chip 504. In this scenario, gateway (GATEWAY 1) loopbacks the data at chip 502. This loopback mechanism, performed using the forward snoop logic circuitry, enables multi-chip DCT without violating the C2C link protocol specification. In addition, the mechanism is compliant with the third-party host and accelerator devices since no changes are needed on those devices. The read request is sent from the requestor to the home node in messages 1-3. In response, the home sends a FWD snoop in message 4 to GATEWAY 1, where it is downgraded to a non-forwarding snoop that is sent the snoop target (ST) in messages 5 and 6. The requested data is sent to GATEWAY 1 in messages 7 and 8, which target the home node. Message 8 is intercepted at GATEWAY 1. The forward snoop logic circuitry reroutes the data to the requestor in messages 9b and 10, bypassing the home node. Optionally, GATEWAY 1 sends a FWD snoop response to the home node in message 9a.

FIG. 5b shows some attributes of the messages in FIG. 5a. As indicated by the left-most broken-line arrow, the node identifier (CHIP_2) of the local requestor is received and stored at GATEWAY 1 in the FWD snoop (message 4) to indicate that the message 3 was received from the second chip. The identifier is copied to the rerouted data message (message 9b) to enable the message to be routed to the original requestor (RN_1). In the embodiment shown, the transaction identifier (Tr) of the original read request (message 1) is also copied to message 9b, as indicated by the right-most broken arrow. In an alternative embodiment, the data address, which is present in all messages, is used to identify the transaction.

GATEWAY 1 stores one or more attributes of the FWD snoop (in this case, the node identifier of the local requestor and, optionally, the transaction identifier of the read request), and uses these attributes to reroute the data message.

In this mechanism, the round-trip routing of the snoop response data between the gateway and the home node is avoided, reducing the latency of the transaction. Latency reduction depends on the size of the network, and may be 20 to 40 cycles, for example.

Thus, in this embodiment, GATEWAY 1 receives regular (non-forwarding) snoop response data on the link, loops the snoop response data back to the requestor, and synthesizes a FWD snoop response to the home node. This completes both snoop request and read request.

### Option 2. Loopback at the Chip-1 Gateway Block (RA).

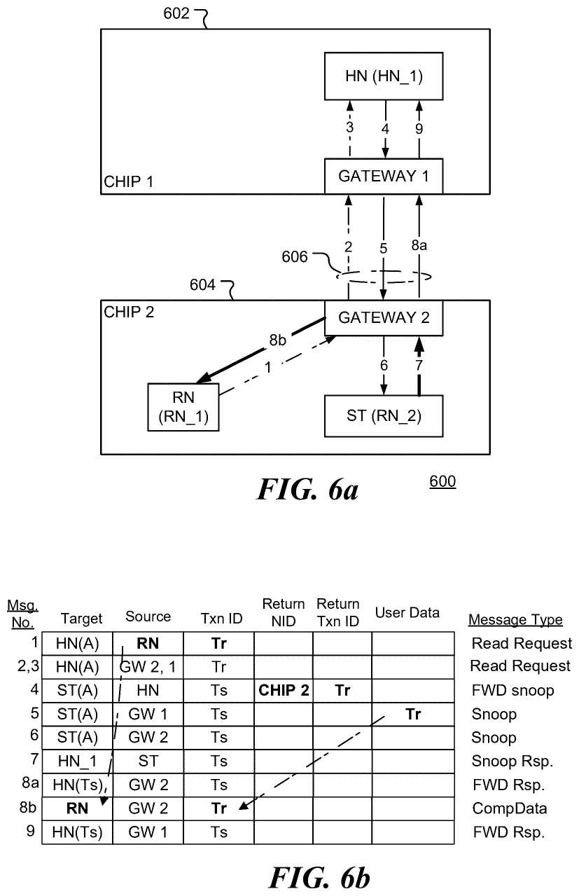

FIG. 6a is a block diagram of a data processing apparatus 600, in accordance with various representative embodiments. As in FIG. 5a, the home node (HN) is in first chip 602, while the original read requestor (RN) and the snoop target (ST) are in second chip 604. In this embodiment, however, gateway (GATEWAY 2) loopbacks the data at chip 504. This loopback mechanism, performed using the forward snoop logic circuitry, enables multi-chip DCT without violating the C2C link protocol specification. The read request is sent from the requestor to the home node in messages 1-3. In response, the home sends a FWD snoop in message 4 to GATEWAY 1, where it is downgraded to a non-forwarding snoop that is sent the snoop target (ST) in messages 5 and 6. The requested data is sent to GATEWAY 2 in message 7, which target the home node. Message 7 is intercepted at GATEWAY 2. The forward snoop logic circuitry in GATEWAY 2 reroutes the data to the requestor in messages 8b, bypassing both the link and the home node. Optionally, GATEWAY 2 sends a FWD snoop response to the home node in messages 8a and 9.

Since the specification of the C2C link protocol does not support FWD snoops, the FWD snoop attributes (such as the node identifier of the requestor) are passed to GATEWAY 2 through designated bits, such as “user” bits, in message 5 or the associated link packets.

The forward node identifier is translated to the chip identifier, and the forward transaction identifier is translated to the C2C transaction identifier for enabling loopback.

This mechanism avoids the latency associated with the round-trip latency of the on-chip mesh and the round-trip latency on the C2C link. For example, this may reduce the latency by 40 to 80 cycles, depending on the size of the mesh and the link technology.

In one embodiment, the snoop request (message 5) sent on the link with a hint attribute (the transaction identifier Tr of the read request in this example) in a designated field (such as the user field). This indicates that the snoop request was downgraded from an earlier FWD snoop request. Similarly, the snoop response (message 8a) is sent on the link with a hint bit in a designated field indicating that the data has been sent directly to the requestor. This response enables GATEWAY 1 to de-allocate the snoop request and other resources, such as trackers, associated with the read transactions. Optionally, GATEWAY 1 synthesizes a FWD snoop response (message 9) to the home node.

This mechanism to enable multi-chip DCT does not violate the C2C link protocol specification. In addition, it does not require the network on chip 604 to support FWD snoops. However, it may not be compliant with the third-party host and accelerator devices, because of the modified behavior of GATEWAY 2.

FIG. 6b shows some attributes of the messages in FIG. 6a. The initial read request is received at GATEWAY 1. The transaction identifier (Tr) and source (RN) are stored in a tracker table. The transaction identifier (Tr) of the read request is received at GATEWAY 1 in the FWD snoop (message 4) and copied to a user data field of a non-forwarding snoop request (message 5) sent to GATEWAY 2. GATEWAY 2 uses the snoop transaction identifier (Ts) to associate the data message (message 7) with message 5 and uses the transaction identifier (Tr) in message 5 to lookup the source (RN) of the read request in the tracker table. This information is used to reroute the data in message 8b to the requestor.

In the embodiments shown in FIGS. 6a and 6a, a link gateway intercepts a data message targeting the home node and re-routes it to the requestor. Thus, the data message bypasses the round-trip to the home node and transaction latency in reduced.

### Option 3. Gateway (RA) Synthesizes the Forward Snoop Request Based on the Hint Bits (No Loopback)

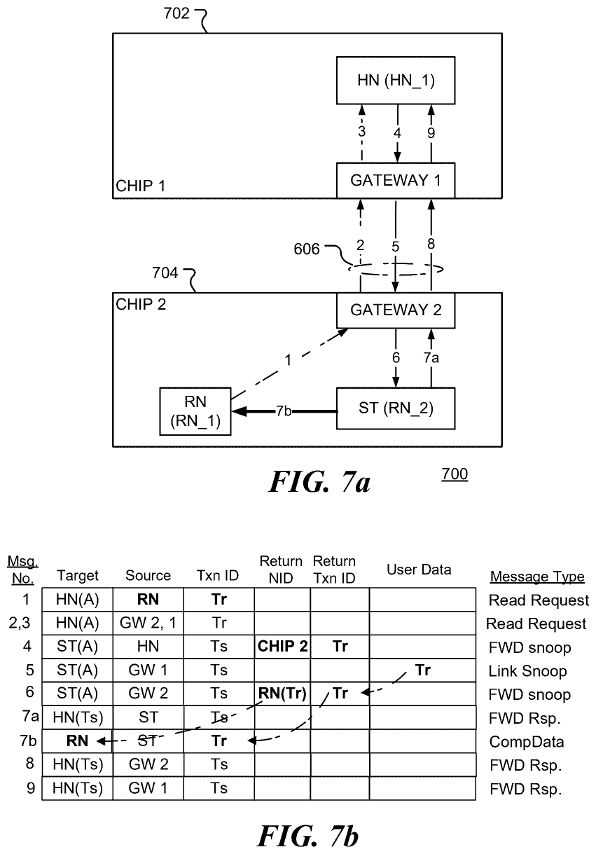

FIG. 7a is a block diagram of a data processing apparatus 700, in accordance with various representative embodiments. As in FIG. 5a, the home node (HN) is in first chip 702, while the original read requestor (RN) and the snoop target (ST) are in second chip (704). In this embodiment, however, the gateway (GATEWAY 2) in second chip 704 synthesizes a FWD snoop (message 6) to the snoop target. This synthesis, performed using the forward snoop logic circuitry, enables multi-chip DCT without violating the C2C link protocol specification. The read request is sent from the requestor to the home node in messages 1-3. In response, the home sends a FWD snoop in message 4 to GATEWAY 1, where it is downgraded to a non-forwarding snoop that is sent over the link in messages 5.

In this embodiment, GATEWAY 2 synthesizes the FWD snoop based on the hint bits on the C2C link snoop request (message 5). This mechanism enables multi-chip DCT without violating the C2C link protocol specification. However, it may not be compliant with some third-party host and accelerator devices, because of the modified behavior of GATEWAY 2. In addition, it requires that the network on chip 704 supports FWD snoops.

When the specification of the C2C link protocol does not support FWD snoops, the forward snoop request attributes are preserved through user data in the message 5. A request node identifier in the message is translated to the chip 2 compliant forward node identifier. If needed, the forward transaction identifier in the message is translated to the chip 2 compliant identifier.

The requested data is sent to GATEWAY 2 in message 7, which targets the home node. Message 7 is intercepted at GATEWAY 2. The forward snoop logic circuitry in GATEWAY 2 reroutes the data to the requestor in messages 8b, bypassing both the link and the home node.

The snoop target sends a snoop response in message 7a to GATEWAY 2 and message 8 to GATEWAY 1. Message 8 may include a hint, such as a bit in the user field, indicating that data was sent directly to the requestor. This response enables the gateway to de-allocate the snoop and read transactions.

Optionally, GATEWAY 1 may synthesize a FWD snoop response (message 9) to the home node.

FIG. 7b shows some attributes of the messages in FIG. 7a. Forward snoop attributes, such as the node identifier (RN_1) of the requestor and a transaction identifier (Tr) are received at GATEWAY 1 in the FWD snoop (message 4). These attributes are copied to a user data field of a non-forwarding snoop request (message 5) and passed to GATEWAY 2. In turn, GATEWAY 2 uses the attributes to synthesize a FWD snoop (message 6) to the snoop target using these attributes. As indicated by the left-most broken-line arrows, the FWD snoop attributes are used by the snoop target to send the data in message 7b directly to the requestor. For example, the node identifier (RN_1) of the requestor is copied to the target identifier of message 7b and is used to route the message to the requestor. Optionally, the transaction identifier of the original read request (message 1) is also copied to message 7b to enable the requestor to associate the data with the original read request. Alternatively, the data address may be used to identify the transaction.

The latency savings include the round-trip latency of the on-chip mesh, the round-trip latency on the C2C link, and additional one-way mesh latency. This may be 50 to 90 cycles, for example, depending on the size of the mesh and the link technology.

A third embodiment of the disclosure relates to Direct Cache Transfer (DCT) when the requestor, snoop target and home node on three separate chips.

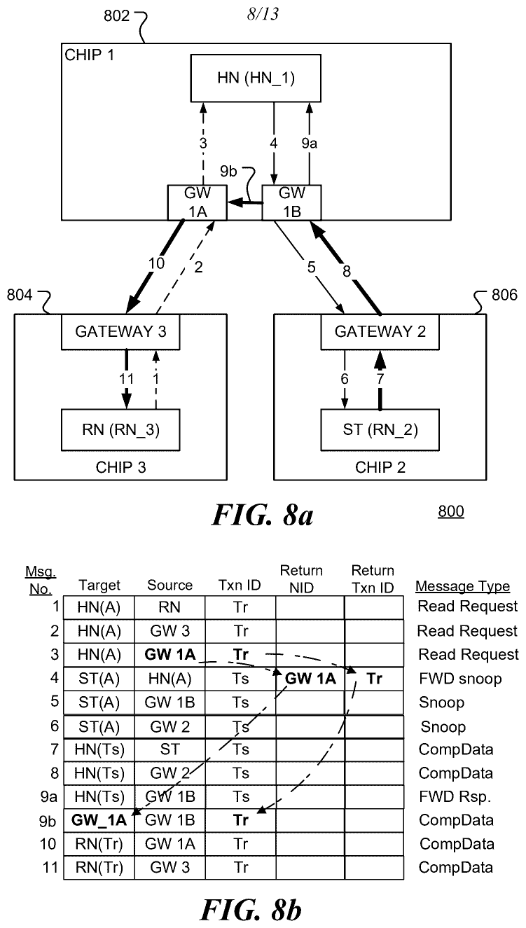

FIG. 8a is a block diagram of a data processing apparatus 800, in accordance with various representative embodiments. Home node (HN) is in first chip 802, the snoop target (ST) is in second chip 804, and the original read requestor (RN) is in third chip 806. In this embodiment, the home node (HN) sends forwarding snoop (message 4) to gateway GW_1A. The snoop is downgraded to a non-forwarding snoop in message 5 and 6, which are sent to the snoop target. The data message is sent back to gateway GW_1A in messages 7 and 8. Gateway GW_1A intercepts the data message and, using routing information in the forwarding snoop (message 4) re-routes the data message to gateway GW_1B, which received the original read request in message 2. From GW_1B, the data message is routed to the requestor in messages 10 and 11. A FWD snoop response may be sent back to the home node in message 9a.

FIG. 8b shows some attributes of the messages in FIG. 8a. Request node routing information, such as the node identifier (RN_1) of the requestor and a transaction identifier (Txn_1), in the original read request (messages 1-3) are used by the home to generate FWD snoop (message 4). This information is stored at gateway GW_1A. When the data message (message 8) is received at GW_1A, the stored routing information is used to re-route the data message to the request node through gateway GW_1B.

In general, routing information in the read request shows at least one step in the path it has taken through the network. When a read request and an associated data message pass through the same gateway, the routing information in the read request may be used to re-route the data message. Alternatively, the routing information can be used to synthesize a FWD snoop that enables the data message to intercepted and/or re-routed sooner.

### GENERIC EMBODIMENTS

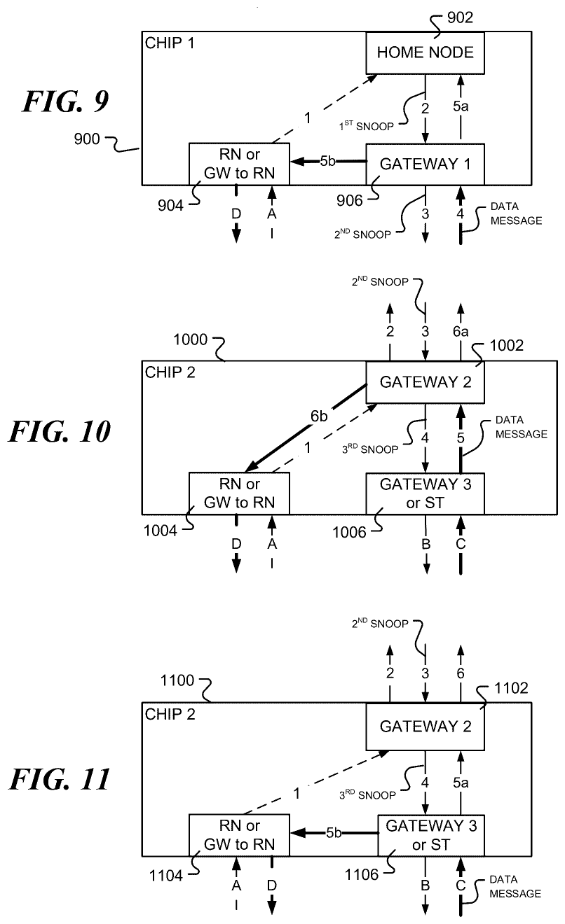

FIG. 9 is a block diagram of a chip, in accordance with various representative embodiments. Chip 900 includes home node 902, requestor node 904, and gateway node 906 of a data processing network. Requestor node 904 may be a local request node in chip 900 or a gateway (GW) to a chip-to-chip link that receives read requests (indicated by message A) from a remote request node on a different chip. Requestor node 904 sends read requests (e.g., message 1) to the home node. Gateway node 906 (GATEWAY 1) is a first gateway to chip-to-chip link that receives forwarding snoop requests (message 2) from the home node, sends snoop requests (message 3) to a remote snoop target on a different chip, and receives data messages (message 4) from the snoop target. In this embodiment, the first gateway intercepts data messages associated with FWD snoops and re-routes them to requestor node 904 in message 5b. When requestor node 904 is a gateway node, the data message is forwarded in message D to the remote request node on a different chip. Optionally, response 5a may be sent to the home node. In this way, the data message bypasses the home node, thereby reducing latency in the read transaction.

As described above, 904 may be gateway to a remote request node. In this embodiment, the gateway may be the same gateway as GATEWAY 1 (as in FIG. 4b) or a different gateway (as in FIG. 8a).

FIG. 10 is a block diagram of a chip 1000, in accordance with various representative embodiments of the disclosure. Chip 1000 includes second gateway 1002 to a home node on a remote chip, requestor node 1004, and snoop node 1006 of a data processing network, Requestor node may be a local request node in chip 1000 or a gateway (GW) to a chip-to-chip link that receives read requests (indicated by message A) from a remote request node on a different chip. Requestor node 1004 sends read requests to the home node via gateway 1002 (messages 1 and 2). Gateway 1002 receives non-forwarding snoop request from the chip-to-chip link in message 3 and sends them to snoop node 1006 in message 4. Snoop node 1006 is either a snoop target or a gateway (GATEWAY 3) to a chip-to-chip link that sends snoop requests (message B) to a snoop target on a remote chip. Snoop node 1006 sends data message 5 to gateway 1002. This may come from the local snoop target or from a remote snoop target via link message C. Gateway 1002 intercepts data message 5 and re-routes to requestor node 1004 in message 6b. Optionally, response 6a may be sent to the home. Non-forwarding snoop request 3 may include a hint in a designated data field to indicate when the snoop was produced by downgrading a FWD snoop. This hint may take the form of a transaction identifier associated with read request. A transaction identifier may be translated between chips, or common. Since the read request (message 1) and the non-forwarding snoop are received at a common gateway (1002), the data message can be associated with the read request at the gateway and re-routed based on routing information in the read request. In this way, the data message bypasses the home node, thereby reducing latency in the read transaction.

FIG. 11 is a block diagram of a chip 1100, in accordance with various representative embodiments of the disclosure. Chip 1100 includes gateway 1102 to a home node on a remote chip, requestor node 1104, and snoop node 1106 of a data processing network, Requestor node may be a local request node in chip 1100 or a gateway to a chip-to-chip link that receives read requests (indicated by message A) from a remote request node on a different chip. Requestor node 1104 sends read requests to the home node via gateway 1102 (messages 1 and 2). Gateway 1102 receives a non-forwarding snoop request from the chip-to-chip link in message 3. Gateway 1102 converts the non-forwarding snoop (message 3) to a forwarding snoop (message 4) and sends it to snoop node 1106. Snoop node 1106 is either a snoop target or a gateway (GW 2) to chip-to-chip link that sends snoop requests (message B) to a snoop target on a remote chip. Snoop node 1106 sends data message 5b to requestor node 1104. The data message may come from the local snoop target or from a remote snoop target via link message C. Optionally, a response may be sent to the home node in messages 5a and 6. Non-forwarding snoop request 3 may in include a hint in a designated data field to indicate when the snoop was produced by downgrading a FWD snoop. This hint may take the form of a transaction identifier associated with read request. Since the read request (message 1) and the non-forwarding snoop are received at a common gateway (1002), the non-forwarding snoop request (message 3) can be associated with the read request at the gateway and forwarding information in the FWD snoop (message 4) can be synthesized based on routing information in the read request. In this way, the data message 5b bypasses the home node, thereby reducing latency in the read transaction.

### Multi-Chip

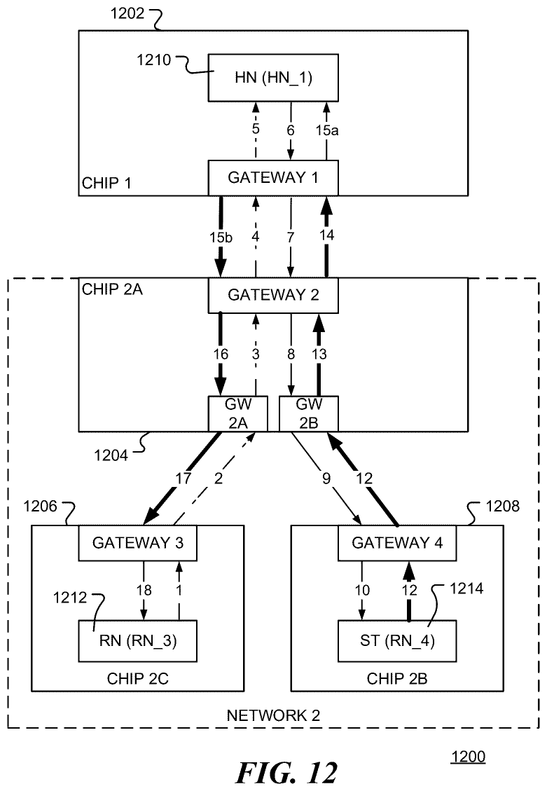

FIGS. 12, 13 and 14 show example embodiments in multi-chip data processing networks, in accordance with various representative embodiments. These examples apply where the request node and snoop target are in different chips (which may be compute-clusters with their own local coherent cache (LCC) or accelerators, for example). The home node may be located in an Input/Output (IO) hub on another chip, for example.

FIG. 12 is a block diagram of a multi-chip data processing apparatus 1200, in accordance with various representative embodiments. The data processing apparatus includes first chip 1202 and a network consisting of chips 1204, 1206 and 1208. Home node 1210 is in first chip 1202, the original read requestor 1212 is on chip 1206 and the snoop target 1214 is in chip 1208. In this embodiment, the data message is intercepted and rerouted on chip 1202, as in FIGS. 8a and 9.

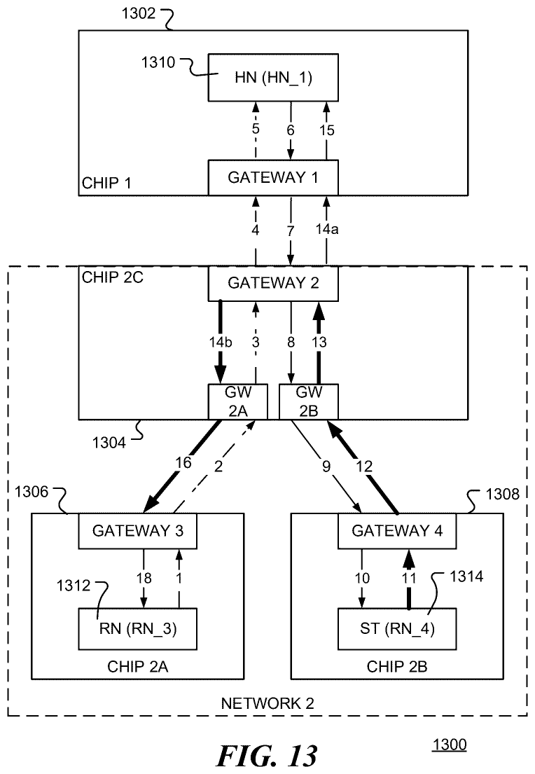

FIG. 13 is a block diagram of a multi-chip data processing apparatus 1300, in accordance with various representative embodiments. The data processing apparatus includes first chip 1302 and a network consisting of chips 1304, 1306 and 1308. Home node 1310 is in first chip 1302, the original read requestor 1312 is on chip 1306 and the snoop target 1314 is in chip 1308. In this embodiment, the data message is intercepted and rerouted on chip 1304, as in FIG. 10.

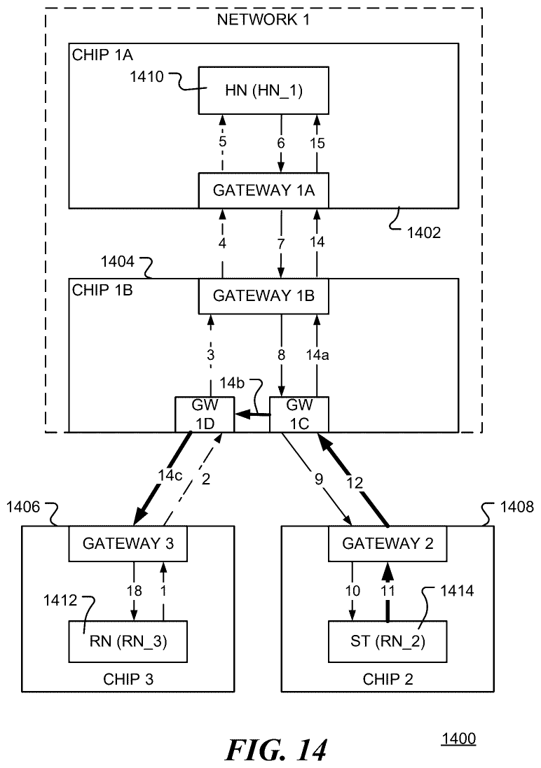

FIG. 14 is a block diagram of a multi-chip data processing apparatus 1400, in accordance with various representative embodiments. The data processing apparatus includes first chip 1402 and a network consisting of chips 1404, 1406 and 1408. Home node 1410 is in first chip 1402, the original read requestor 1412 is on chip 1406 and the snoop target 1414 is in chip 1408. In this embodiment, the data message is intercepted and rerouted on chip 1404, as in FIG. 11.

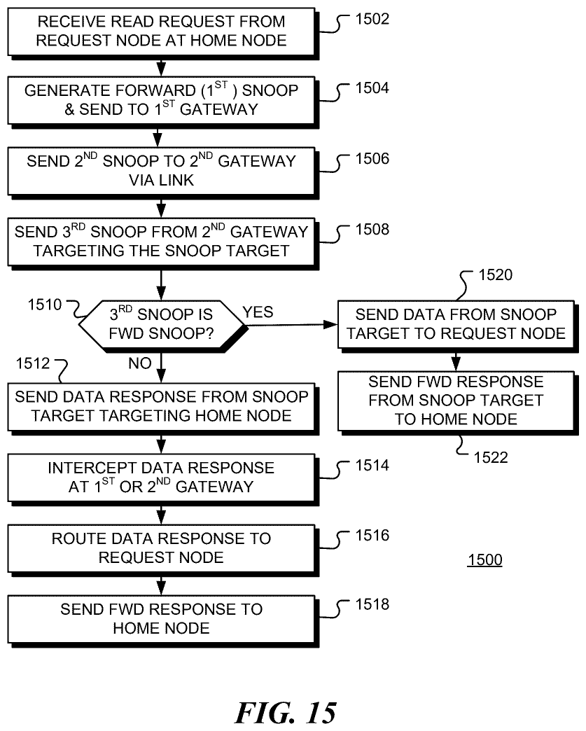

FIG. 15 is a flow chart of a method of data transfer in a data processing apparatus, in accordance with various representative embodiments. Responsive to receiving, at a home node of a first network, a read request from a request node of the data processing apparatus at block 1502, a first snoop request is generated at block 1504 targeting a snoop target of a second network. The first snoop request is a forwarding snoop request, and the second network is operatively coupled to the first network by a link. The first snoop is sent to the first gateway of the link, located in the first network. At block 1506, responsive to receiving the first snoop request at the first gateway, a second snoop request is sent to a second gateway of the link, located on the second network, in accordance with a link protocol. The second snoop request is a non-forwarding snoop request. Responsive to receiving the second snoop request, the second gateway generates a third snoop request as a forwarding snoop request or a non-forwarding snoop request targeting the snoop target at block 1506. The snoop target sending data associated with the read request in a data message responsive to receiving the third snoop request, or a snoop request derived therefrom. When the third snoop request is a non-forwarding snoop request, as indicated by the negative branch from decision block 1510, the data message is sent from the snoop target targeting the home node at block 1512, but intercepted at the first or second gateway and routing the data message to the request node at block 1514. The data message is then routed to the request node at block 1516. Optionally, a FWD response is sent to the home node at block 1518. When the third snoop request is a forwarding snoop request, as indicated by the positive branch from decision block 1510, the data message is sent from the snoop target targeting the request node at block 1520. Optionally, a FWD response is sent from the snoop target to the home node at block 1522.

In this document, relational terms such as first and second, top and bottom, and the like may be used solely to distinguish one entity or action from another entity or action without necessarily requiring or implying any actual such relationship or order between such entities or actions. The terms “comprises,” “comprising,” “includes,” “including,” “has,” “having,” or any other variations thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

Reference throughout this document to “one embodiment,” “certain embodiments,” “an embodiment,” “implementation(s),” “aspect(s),” or similar terms means that a particular feature, structure, or characteristic described in connection with the embodiment is included in at least one embodiment of the present disclosure. Thus, the appearances of such phrases or in various places throughout this specification are not necessarily all referring to the same embodiment. Furthermore, the particular features, structures, or characteristics may be combined in any suitable manner in one or more embodiments without limitation.

The term “or,” as used herein, is to be interpreted as an inclusive or meaning any one or any combination. Therefore, “A, B or C” means “any of the following: A; B; C; A and B; A and C; B and C; A, B and C.” An exception to this definition will occur only when a combination of elements, functions, steps, or acts are in some way inherently mutually exclusive.

As used herein, the term “configured to,” when applied to an element, means that the element may be designed or constructed to perform a designated function, or that is has the required structure to enable it to be reconfigured or adapted to perform that function.

Numerous details have been set forth to provide an understanding of the embodiments described herein. The embodiments may be practiced without these details. In other instances, well-known methods, procedures, and components have not been described in detail to avoid obscuring the embodiments described. The disclosure is not to be considered as limited to the scope of the embodiments described herein.

Those skilled in the art will recognize that the present disclosure has been described by means of examples. The present disclosure could be implemented using hardware component equivalents such as special purpose hardware and/or dedicated processors which are equivalents to the present disclosure as described and claimed. Similarly, dedicated processors and/or dedicated hard wired logic may be used to construct alternative equivalent embodiments of the present disclosure.

Dedicated or reconfigurable hardware components used to implement the disclosed mechanisms may be described, for example, by instructions of a hardware description language (HDL), such as VHDL, Verilog or RTL (Register Transfer Language), or by a netlist of components and connectivity. The instructions may be at a functional level or a logical level or a combination thereof. The instructions or netlist may be input to an automated design or fabrication process (sometimes referred to as high-level synthesis) that interprets the instructions and creates digital hardware that implements the described functionality or logic.

The HDL instructions or the netlist may be stored on non-transitory computer readable medium such as Electrically Erasable Programmable Read Only Memory (EEPROM); non-volatile memory (NVM); mass storage such as a hard disc drive, floppy disc drive, optical disc drive; optical storage elements, magnetic storage elements, magneto-optical storage elements, flash memory, core memory and/or other equivalent storage technologies without departing from the present disclosure. Such alternative storage devices should be considered equivalents.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define an HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioral representations of the concepts that can be interpreted by a computer to enable simulation, functional and/or formal verification, and testing of the concepts.

Additionally, or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively, or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively, or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed of in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

Various embodiments described herein are implemented using dedicated hardware, configurable hardware or programmed processors executing programming instructions that are broadly described in flow chart form that can be stored on any suitable electronic storage medium or transmitted over any suitable electronic communication medium. A combination of these elements may be used. Those skilled in the art will appreciate that the processes and mechanisms described above can be implemented in any number of variations without departing from the present disclosure. For example, the order of certain operations carried out can often be varied, additional operations can be added, or operations can be deleted, without departing from the present disclosure. Such variations are contemplated and considered equivalent.

The various representative embodiments, which have been described in detail herein, have been presented by way of example and not by way of limitation. It will be understood by those skilled in the art that various changes may be made in the form and details of the described embodiments resulting in equivalent embodiments that remain within the scope of the appended claims.

What is claimed:

1. A method of data transfer in a data processing apparatus, comprising:
responsive to receiving, at a home node of a first network, a read request from a request node of the data processing apparatus:
generating a first snoop request targeting a snoop target of a second network, where the first snoop request is a forwarding snoop request, and the second network is operatively coupled to the first network by a link;
responsive to receiving the first snoop request at a first gateway of the link, located in the first network:
transporting a second snoop request to a second gateway of the link, located on the second network, in accordance with a link protocol, where the second snoop request is a non-forwarding snoop request;
responsive to receiving the second snoop request at the second gateway:
generating a third snoop request as a forwarding snoop request or a non-forwarding snoop request targeting the snoop target;
the snoop target sending data associated with the read request in a data message responsive to receiving the third snoop request, or a snoop request derived therefrom; and
when the third snoop request is a non-forwarding snoop request:
intercepting the data message at the first or second gateway and routing the data message to the request node.

2. The method of claim 1, further comprising, when the third snoop request is a forwarding snoop request and the snoop target in located on the same chip as the second gateway:
receiving the read request at the second gateway;
synthesizing, at the second gateway, the third snoop request as a forwarding snoop request based, at least in part, on one or more identifiers of the request node in the read request;
sending the third snoop request to the snoop target; and
the snoop target sending a snoop response message to the request node responsive to receiving the third snoop request.

3. The method of claim 1, where the snoop target is located on a different chip to the second gateway, the different chip accessible via a third gateway, the method further comprising:
receiving the read request at the second gateway;
synthesizing, at the second gateway, the third snoop request as a forwarding snoop request based, at least in part, on one or more identifiers of the request node in the read request;
sending the third snoop request to the third gateway; and
the third gateway intercepting the data message from the snoop target and routing the data message to the request node.

4. The method of claim 1, where intercepting the data message at the link and re-routing the data message to the request node is performed at the first gateway of the link, based request node routing information in the first snoop request.

5. The method of claim 1, where the read request is routed through the second gateway, the method further comprising:
setting a hint bit in the second snoop request indicating that the first snoop request was a forwarding snoop request,
where intercepting the data message at the link and re-routing the data message to the request node is performed at the second gateway of the link based, at least in part, on request node routing information in the read request.

6. The method of claim 1, where the read request is routed through the second gateway, the method further comprising:
setting a hint bit in the second snoop request indicating that the first snoop request was a forwarding snoop request; and
when the third snoop request is a forwarding snoop request:
synthesizing, at the second gateway, the third snoop request as a forwarding snoop request based, at least in part, on request node routing information in the read request.

7. The method of claim 1, further comprising:
copying, at the first gateway, request node routing information from the first snoop request to one or more designated fields of the second snoop request; and
storing, at the second gateway, the request node routing information.

8. The method of claim 7, where, when the third snoop request is a non-forwarding snoop request, intercepting the data message at the link and re-routing the data message to the request node includes:
intercepting the data message at the second gateway; and
re-routing the data message from the second gateway to the request node based on the request node routing information in the one or more designated fields of the second snoop request.

9. The method of claim 1, where the first network is on a different chip or chiplet from the second network, and where the link is a chip-to-chip link that does not support forwarding snoops.

10. A data processing apparatus comprising:
a link having a first gateway and a second gateway;
a first network including a home node and the first gateway;
a second network including a snoop target and the second gateway, the second network operatively coupled to the first network via the link; and
a request node;
where:
the request node is configured to send a read request to the home node;
the home node is configured to send, responsive to receiving the read request, a first snoop request to the first gateway, where the first snoop request is a forwarding snoop request;
the first gateway is configured to send, responsive to receiving the first snoop request, a second snoop request to the second gateway via the link, in accordance with a link protocol, where the second snoop request is a non-forwarding snoop request; and
the second gateway is configured to send, responsive to receiving the second snoop request, a third snoop request targeting a snoop target, where the third snoop request is a forwarding snoop request or a non-forwarding snoop request;
and
where, when the third snoop request is not a forwarding snoop request, the first or second gateway of the link is configured to intercept a data message from the snoop target and re-route it to the request node.

11. The data processing apparatus of claim 10, where at least one of the first and second gateways includes:
a transmitter configured to pass messages to the link;
a receiver configured to receive messages from the link; and
forward snoop logic circuitry coupled to the transmitter and to the receiver,
where the forward snoop logic circuitry is configured to:
store request node routing information received in the first snoop request;
intercept a data message from the snoop target;
determine when the data message is associated with the first snoop request; and
when the data message is associated with the first snoop request, send the data message from the first gateway to the request node, based on the request node routing information.

12. The data processing apparatus of claim 11, where the first network is on a different chip or chiplet from the second network, and where the link is a chip-to-chip link that does not support forwarding snoops.

13. A data processing apparatus comprising:
a gateway to a chip-to-chip link of a data processing apparatus, where the gateway includes:
a transmitter configured to pass messages to a chip-to-chip link, where the link is configured to couple between first and second chips of a data processing apparatus;
a receiver configured to receive messages from the chip-to-chip link; and
forward snoop logic circuitry coupled to the transmitter and to the receiver,
where the forward snoop logic circuitry is configured to:
store request node routing information for a request node of the data processing apparatus, where the request node routing information is obtained from a read request from the request node or from a first snoop request, where the first snoop request is a forwarding snoop request generated by a home node of the first chip in response to the read request, and where the first snoop request targets a snoop target on the second chip;
intercept a data message from the snoop target;
determine when the data message is a snoop response associated with read request; and
when the data message is a snoop response associated with read request, send the data message from the gateway to the request node, based on the request node routing information.

14. The data processing apparatus of claim 13, where the gateway is further configured to:
receive, at the transmitter, the first snoop request from the home node; and
send a second snoop request, via the transmitter and the link to the second chip, where the second snoop request is a non-forwarding message.

15. The data processing apparatus of claim 14, where the chip includes a network, the network includes the home node, and the home node is coupled to the gateway via an interconnect.

16. The data processing apparatus of claim 13, where the gateway is further configured to:
receive, at the receiver from the link, a second snoop request, where the second snoop request is a non-forwarding message generated from the first snoop request; and
retrieve the one or more attributes of the read request from one or more designated data fields in the second snoop request.

17. The data processing apparatus of claim 16, where the chip includes a network, the network includes the snoop target, and the snoop target coupled to the gateway via an interconnect.

18. The data processing apparatus of claim 13, where the forward snoop logic circuitry is further configured to loop the data message from the receiver to the transmitter.

19. The data processing apparatus of claim 13, where the forward snoop logic circuitry is further configured to loop the data message from the transmitter to the receiver.

20. A non-transitory computer-readable medium storing computer-readable code for fabrication of the gateway of claim 13 in a chip.
